(19) United States
(12) Patent Application Publication
(10) Pub. No.: US 2014/0007244 A1
(43) Pub. Date: Jan. 2, 2014

(54) SYSTEMS AND METHODS FOR GENERATING RISK ASSESSMENTS

(71) Applicants: Daniel Martin, Edwardsville, IL (US); Micheal Kemp, West Fargo, ND (US); Daiko Abe, Fargo, ND (US)

(72) Inventors: Daniel Martin, Edwardsville, IL (US); Micheal Kemp, West Fargo, ND (US); Daiko Abe, Fargo, ND (US)

(73) Assignee: INTEGRATED SOLUTIONS CONSULTING, INC., Edwardsville, IL (US)

(21) Appl. No.: 13/930,801

(22) Filed: Jun. 28, 2013

Related U.S. Application Data
(60) Provisional application No. 61/665,493, filed on Jun. 28, 2012.

(51) Int. Cl. G06F 21/57

(52) U.S. Cl. CPC G06F 21/577
USPC 726/25

(57) ABSTRACT

Aspects of the present disclosure involve methods and systems for generating risk assessments that quantify real-time and/or near real-time threats, risks, dangers, hazards, uncertainties, and/or vulnerabilities for businesses, governments, cities, and/or other types of communities. One or more interfaces may be generated for receiving threat assessment data. The threat assessment data is processed to generate one or more risk assessments and/or risk summaries.

### CROSS REFERENCE TO RELATED APPLICATION

The present non-provisional utility application claims priority under 35 U.S.C. §119(e) to co-pending provisional application No. 61/665,493 entitled “Systems And Methods For Threat-Hazard Identification Risk Assessment,” filed on Jun. 28, 2012, and which is hereby incorporated by reference herein.

### TECHNICAL FIELD

Aspects of the present disclosure relate to methods and systems for managing hazard risk, and in particular, for generating hazard risk assessments.

### BACKGROUND

Hazard risk assessment is the process of identifying potential hazard threats and analyzing what could happen if any of such hazards were to materialize. A hazard represents any act, consequence, or opportunity that is potentially costly, harmful, or undesirable, which leads to impacts. The connection between hazards and risks is an event—a situation in which someone or something is exposed to the hazard. For example, a structurally deficient bridge in an urban area represents a hazard because it could cause harm. To assess the risk associated with the deficient bridge hazard, a particular event involving the hazard must be identified, such as for example, an earthquake occurring while motorists are traveling on the structurally deficient bridge. Once an event has been identified, the probability and severity of the event and any risks associated with the event may be determined.

Properly assessing risk is critical for effective decision making, particularly when attempting to identify risks associated with hazards affecting human life, property, and/or the environment. Decisions should be made using the best available knowledge that is based on the most accurate and up-to-date information concerning the potential hazards and their likely impacts and consequences. However, conventional risk assessment systems typically rely on fragmented, outdated, and unreliable data and involve substantial amounts of manual processing that is often influenced by an individual's bias and perception of hazard risk.

Moreover, such risk assessment system only assess one type of risk, even though there may be many different types of risk associated with a given event.

It is with these concepts in mind, among others, that various aspects of the present disclosure were conceived and developed.

### SUMMARY

Aspects of the present disclosure include systems for assessing a risk of a hazard. The system includes at least one processor. The at least one processor is configured to receive threat assessment data corresponding to a community. The threat assessment data includes a vulnerability assessment, a capability and capacity assessment, and a hazard assessment. The at least one processor is further configured to process the vulnerability assessment, the capability and capacity assessment, and the hazard assessment to calculate at least one risk assessment score quantifying a risk of a threat associated with the community. The at least one processor is configured to transmit the at least one risk assessment score for display.

Aspects of the present disclosure include methods for assessing a risk of a hazard. The method, executable by at least one processor includes receiving, at the least one processor, a threat assessment data corresponding to a community, the threat assessment data including a vulnerability assessment, a capability and capacity assessment, and a hazard assessment. The method further includes processing the vulnerability assessment, the capability and capacity assessment, and the hazard assessment to calculate at least one risk assessment score quantifying a risk of a threat associated with the community. The method includes transmitting, at the at least one processor, the at least one risk assessment score for display.

Aspects of the present disclosure include non-transitory computer readable mediums medium including instructions for assessing risk of a hazard, the instructions, executable by a processor, include receiving a threat assessment data corresponding to a community, the threat assessment data including a vulnerability assessment, a capability and capacity assessment, and a hazard assessment. The instructions further include processing the capability and capacity assessment, and the hazard assessment to calculate at least one risk assessment score quantifying a risk of a threat associated with the community. The instructions include transmitting the at least one risk assessment score for display.

### BRIEF DESCRIPTION OF THE DRAWINGS

The foregoing and other objects, features, and advantages of the present disclosure set forth herein should be apparent from the following description of particular embodiments of those inventive concepts, as illustrated in the accompanying drawings. It should be noted that the drawings are not necessarily to scale; however, the emphasis instead is being placed on illustrating the principles of the inventive concepts. Also, in the drawings the like reference characters refer to the same parts throughout the different views. The drawings depict only typical embodiments of the present disclosure and, therefore, are not to be considered limiting in scope.

FIG. 1 is a flow chart for generating risk assessments, according to aspects of the present disclosure.

FIG. 2 is block diagram illustrating a computing environment for generating risk assessments, according to aspects of the present disclosure.

FIGS. 3A-3B are example screen shots of the risk management application, according to aspects of the present disclosure.

FIGS. 4A-4B is an example risk assessment summary, according to aspects of the present disclosure.

FIG. 5 is an example computing environment, according to aspects of the present disclosure.

### DETAILED DESCRIPTION

Aspects of the present disclosure involve methods and systems for processing data to generate various assessments that quantify real-time and/or near real-time threats, risks, dangers, hazards, uncertainties, and/or vulnerabilities for businesses, governments, cities, and/or other types of communities or entities (collectively referred to herein as “communities”). More specifically, one or more interactive interfaces may be generated that enable a user to provide threat assessment data corresponding to a particular community. The threat assessment data may be processed to generate one or more assessments, risk values, heuristics, vulnerability assessments, etc. For example, various embodiments may include the calculation of one or more risk scores and the generation of a risk assessment summary. Graphical representations of any identified threats, risks, and generated scores and assessments may be provided or otherwise displayed for analysis by a user.

Risk assessment generally refers to the quantification of risk related to a specific situation and a recognized threat or hazard. Stated differently, risk assessment is a process to identify potential hazards for a given community and analyze what could happen if such a hazard occurs. Recognizing the potential hazards that may impact a community, and assessing the level of risk, will largely influence the kind of resources, policies, and operation-specific procedures and protocols necessary to prepare for, mitigate against, respond to, or recover from a hazardous event. In any type of community, sophisticated risk assessments are made with respect to given hazard, when the hazard concerns threats to life, environment, the economy, etc.

Assessing risks may present many challenges as the probability or severity of a hazardous event may not be known (e.g., the probability that your car will break down tomorrow), or not agreed-upon (e.g., the severity of global warming). Moreover, many different types of community factors may be associated with a given hazard. Among the most prominent types are safety, cost, schedule, technical, and political risk, and most decisions involve more than one. Conventional risk assessment methodologies typically only rely on the hazard itself and do not consider any community factors when performing risk assessment. Aspects of the present disclosure rely on many different types of assessments and community factors during the generation of risk assessments, risk assessment aggregations, or the like.

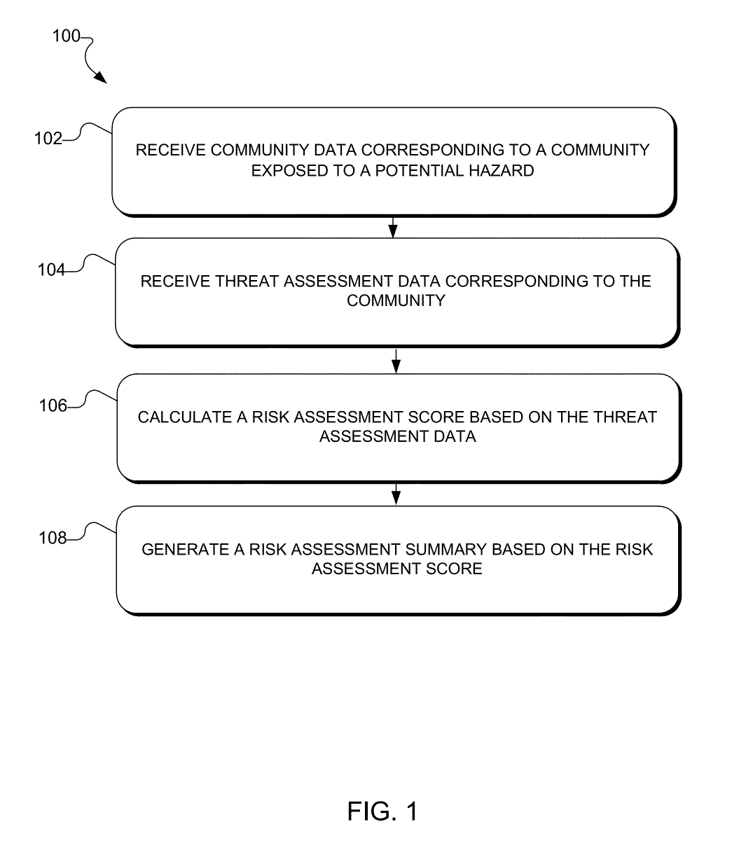

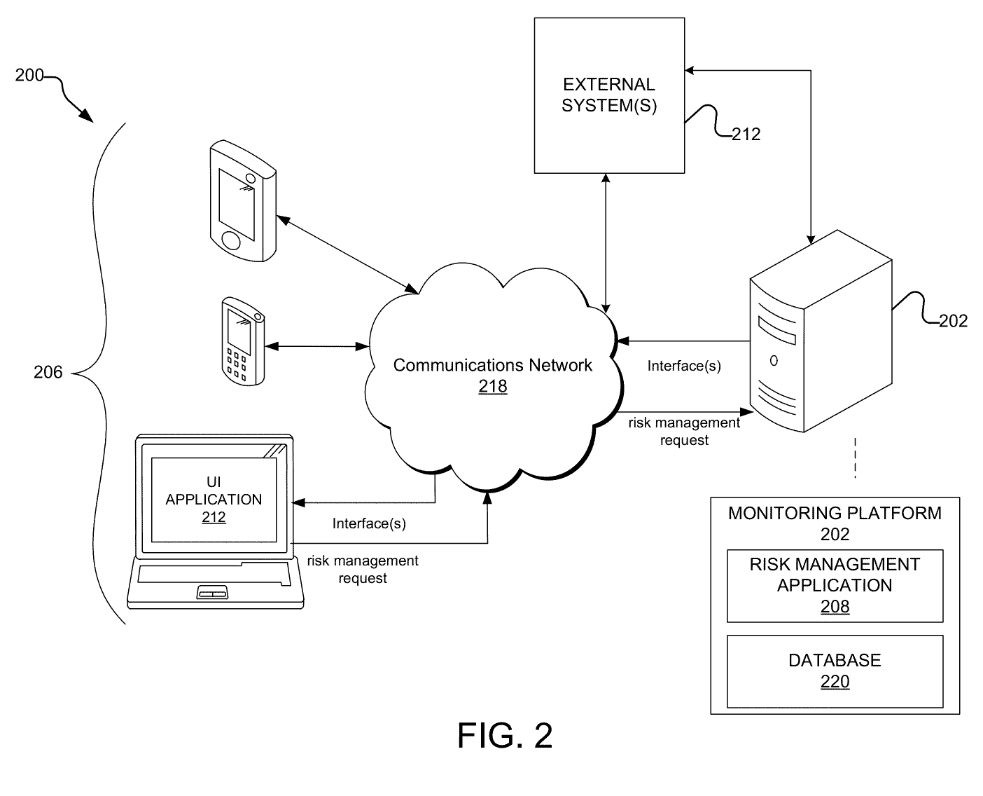

An illustrative process and system for generating risk assessments for a community is depicted in FIGS. 1-2. In particular, FIG. 1 illustrates an example process 100 for calculating risk assessment values and/or generating risk assessment aggregations. FIG. 2 illustrates a computing environment 200 including a risk management system 202 configured to identify hazards, threats, vulnerabilities, and the like and generate any risk assessments. Thus, FIG. 2 illustrates a computing environment 200 including the risk management system 202 operating in conjunction with various other hardware and/or software components (operating on hardware) that may be used to perform or otherwise execute the process 100.

Referring now to FIG. 1, process 100 begins with receiving community data corresponding to a community facing a potential hazard (operation 102). Community data may identify a specific community, such as a local municipality, a private business, a state, or specific geographical region, and further, may include basic demographic, historical, cultural, environmental, and/or other relevant community data that provides a description of the identified community. Thus, in various embodiments, the community data may include information unique to a specific community (e.g. a city or business) and various characteristics of the specific community, such as its political governance, economical circumstances, geography, climate, population, community assets, future development and trends, and the like. It is contemplated that any type of characteristic information corresponding to community which may be used in determining risks or threats may be included within the community data.

In one particular embodiment the community data may be received as part of a community profile. The community profile provides a general descriptive overview of various community attributes or elements, such as historical background, location, political boundaries and governance, geography, hydrology, climate, political governance, development trends (current and future), population size, etc. For example, assume a public health department is interested in developing and expanding their public health comprehensive emergency management program by implementing an all-hazard and comprehensive operational program. A community profile may be received describing various demographic, historical, cultural, environmental, and/or other relevant data corresponding to the public health department.

In addition to receiving community data, threat assessment data corresponding to the community may be received (operation 104). Threat assessment data represents data and/or information related to or otherwise concerned with a risk, threat, and/or hazard for the community. Common community threats include environmental threats, such as floods, earthquakes, droughts, tornados; political threats, such as terrorist attacks, riots, and civil disobedience; criminal threats; and the like. Thus, referring to the public health department example above, threat assessment data articulating various hazards, such as the probability of a pandemic or epidemic, or deficiencies within one or more of the health department's health care facilities may be received as threat assessment data. In one particular embodiment, the threat assessment data may include or otherwise be divided into three different types and/or categories of assessments: a vulnerability assessment; a capability and capacity assessment; and a hazard assessment.

The vulnerability assessment defines the conditional probability of protective systems or infrastructure of a community failing due to a natural hazard event. The vulnerability hazard may be sub-categorized as physical, social, or community based. The physical vulnerabilities of a community consist of the tangible assets, or built environment, that residents depend upon to provide shelter, facilitate connectivity of the community, and enable the provisioning of goods and/or resources. The built environment provides the setting for human activity, ranging in scale from personal residential structures and buildings to neighborhoods and cities that can often include their supporting infrastructure, such as transportation networks, energy or water systems. Social vulnerabilities may be defined as the characteristics of a person or group within a particular community and their corresponding circumstances that may influence their capacity to anticipate, cope with, resist and recovery from the impact of a hazard or threat. Social vulnerability may also be defined as the susceptibility of social groups to the impacts of hazards, as well as their resiliency or ability to adequately recover from them. Community-level and/or community vulnerabilities are measures of conditions within a community that articulate how the community and its vulnerabilities may be impacted during a hazardous event. For example, the community vulnerabilities may include seven (7) indicator categories: economic conditions; social conditions; environmental conditions; governmental conditions; insurance; special properties; and faith-based community characteristics.

The capability and capacity assessment defines the amount of resources available to or within a community that may be consumed to promote its safety and well-being. Capacity (e.g. community capacity) may be defined as the amount of resources available to a community that may be used to execute or carry out certain functions to promote its safety and well-being. Capability may be defined or quantified as the actual ability of a community to perform actions necessary to anticipate, prevent, prepare for, cope with, respond to, or recover from the impact of a hazard. The purpose of delineating capability and capacity is to illustrate that having capacity does not necessarily translate into being capable of executing such actions or otherwise consuming such capacity. Capacity expresses the potential to act accordingly based on the availability of resources, which can be both tangible and intangible, whereas capability represents total of the knowledge, support, and experience required to perform or accomplish a certain task—both capacity and capability may be relevant to hazard, threat, and/or risk assessment.

The capability and capacity assessment may be organized into the following sub-categories: community capacity and emergency capabilities. Emergency capabilities defines and/or quantifies the various plans and/or procedures, level of preparedness for emergencies and implement hazard protection and resiliency measures in the event of an emergency. For example and referring to the health department example, community capacity may include an array of indicators that measure the health department's resource capacity such as adequate staffing, adequate funding reserves to manage the event, the support of department and community leadership, and the positive morale of the department. Emergency capabilities may include a myriad of indicator categories such as a health department's progress towards community preparedness, the ability of the health department to share of crisis information with key stakeholders, or the ability of the organize to implement and manage mass fatality events.

The hazard assessment defines and/or identifies all relevant hazards that may impact a community. The hazards may be categorized into numerous categories, some of which include: Natural, Technological, Crime/Terrorism, and Public Health. For example, natural hazards may include droughts, floods, tornados, earthquakes, extreme winter weather, and the like. Technological hazards may include structural fires, utility failures, hazardous materials, etc. Crime/Terrorism hazards may include terrorist acts and cyber-security crimes. Public health hazards may include Pandemic/Epidemics, Animal and Plant Disease Outbreak, Water Contamination, among others.

The following table provides example assessments values, sub categories, quantifications, and the like, that may be calculated or otherwise included within the assessment data (e.g. within the vulnerability assessment, capability and capacity assessment, and hazard assessment):

TABLE 1
Assessments

| Assessment | Calculation |
|---|---|
| Physical Vulnerability - Critical Infrastructure | Average response score for each variable (i.e. |
| | energy sector, wastewater treatment, airport, etc) |
| Physical Vulnerability - Key Resources | Average response score for each variable (i.e. |
| | schools, museums, universities, emergency |
| | services, etc) |
| Physical Vulnerability - Building Stock | Average response score for each variable (i.e. |
| | residential, commercial, government, etc) |
| Physical Vulnerability Assessment | Average overall score for critical infrastructure, key |
| | resources, and building stock |
| Social Vulnerability - Special Populations | Average response score for each variable (i.e. |
| | children, elderly, disabled, etc) |
| Social Vulnerability - Cultural Conditions | Average response score for each variable (i.e. low |
| | income, literacy, level of education, etc) |
| Social Vulnerability - Socio Economic | Average response score for each variable (i.e. |
| | income, social dependence, home ownership, etc) |
| Social Vulnerability Assessment | Average overall score for Special Populations, |
| | Cultural Conditions, Socio Economic |
| Community Conditions Vulnerability | Average response score for each variable (i.e. |
| | economic conditions, environmental conditions, |
| | governmental conditions, etc) |
| Community Capabilities & Capacities Assessment | Average response score for each variable (i.e. |
| | staffing, funding, political support, emergency |
| | management, homeland security, etc) |
| Hazard Assessment - Frequency & Probability | Average response score for each variable used to |
| | measure the frequency and probability of the |
| | hazard (i.e. probability of event, predictive models, |
| | etc) |
| Hazard Assessment - Magnitude & Scale | Average response score for each variable used to |
| | measure potential magnitude and scale of hazard |
| | (i.e. probability of catastrophic, magnitude of past |
| | events, etc) |
| Hazard Assessment - Casualties & Fatalities | Average response score for each variable used to |
| | measure potential extent of mass casualty/fatality |
| | (i.e. potential for mass casualty, fatalities from past |
| | events, etc) |
| Hazard Assessment - Damages | Average response score for each variable used to |
| | measure potential extent of damage (i.e. crop |
| | damages, property, business interruption, etc) |
| Hazard Assessment - Hazard Specific Mitigation | Average response score for each variable used to |
| | measure mitigation efforts for the hazard (i.e. |
| | regulations and policies, structural, nonstructural, |
| | goal achievement, etc) |
| Hazard Assessment - Hazard Specific Capabilities | Average response score for each variable used to |
| | measure capability to manage hazard (i.e. level of |
| | preparedness, funding, staffing, etc) |
| Hazard Impact Assessment - Critical Infrastructure | =(Overall vulnerability score for Critical |
| | (Infrastructure from the Physical Vulnerability |
| | Assessment)\hat{ }(1/Hazard Impact Assessment |
| | Response) |
| Hazard Impact Assessment - Key Resources | =(Overall vulnerability score for Key Resources |
| | from the Physical Vulnerability |
| | Assessment)\hat{ }(1/Hazard Impact Assessment |
| | Response) |
| Hazard Impact Assessment - Building Stock | =(Overall vulnerability score for Building Stock |
| | from the Physical Vulnerability |
| | Assessment)\hat{ }(1/Hazard Impact Assessment |
| | Response) |
| Hazard Impact Assessment - Physical Impacts | Average response score for Critical Infrastructure, |
| | Key Resources, and Building Stock Hazard Impact |
| | Assessments |
| Hazard Impact Assessment - Special Populations | =(Overall vulnerability score for Special |
| | Populations from the Social Vulnerability |
| | Assessment)\hat{ }(1/Hazard Impact Assessment |
| | Response) |
| Hazard Impact Assessment - Cultural Conditions | =(Overall vulnerability score for Cultural |
| | Conditions from the Social Vulnerability |
| | Assessment)\hat{ }(1/Hazard Impact Assessment |
| | Response) |
| Hazard Impact Assessment - Socio Economic | =(Overall vulnerability score for Socio Economic |
| | from the Social Vulnerability |
| | Assessment)\hat{ }(1/Hazard Impact Assessment |
| | Response) |
| Hazard Impact Assessment - Social Impacts | Average response score for Special Populations, |
| | Cultural Conditions, and Socio Economic Hazard |
| | Impact Assessments |
| Hazard Impact Assessment - Economic Conditions | =(Overall vulnerability score for Economic |
| | Conditions from the Community Conditions |
| | Vulnerability Assessment)\hat{ }(1/Hazard Impact |
| | Assessment Response) |
| Hazard Impact Assessment - Social Conditions | =(Overall vulnerability score for Social Conditions |
| | from the Community Conditions Vulnerability |
| | Assessment)\hat{ }(1/Hazard Impact Assessment |
| | Response) |
| Hazard Impact Assessment - Environmental | =(Overall vulnerability score for Environmental |
| Conditions | Conditions from the Community Conditions |
| | Vulnerability Assessment)\hat{ }(1/Hazard Impact |
| | Assessment Response) |
| Hazard Impact Assessment - Governmental | =(Overall vulnerability score for Governmental |
| Conditions | Conditions from the Community Conditions |
| | Vulnerability Assessment)\hat{ }(1/Hazard Impact |
| | Assessment Response) |
| Hazard Impact Assessment - Insured Risk | =(Overall vulnerability score for Economic |
| Conditions | Conditions from the Community Conditions |
| | Vulnerability Assessment)\hat{ }(1/Hazard Impact |
| | Assessment Response) |
| Hazard Impact Assessment - Special Properties | =(Overall vulnerability score for Special Properties |
| | from the Community Conditions Vulnerability |
| | Assessment)\hat{ }(1/Hazard Impact Assessment |
| | Response) |
| Hazard Impact Assessment - Faith Based | =(Overall vulnerability score for Faith Based |
| Community | Community from the Community Conditions |
| | Vulnerability Assessment)\hat{ }(1/Hazard Impact |
| | Assessment Response) |
| Hazard Consequence | =((Hazard Assessment − Frequency & Probability |
| | Score) + (Hazard Assessment − Magnitude & Scale |
| | Score) + (Hazard Assessment − Casualties & |
| | Fatalities Score) + (Hazard Assessment − |
| | Damages Score)/4) + Physical Hazard Impact |
| | Score + Social Hazard Impact Score + Community |
| | Conditions Hazard Impact Score + ((1/Capabilities |
| | & Capacities Assessment Score) * .25) + ((1/Hazard |
| | Specific Mitigation Score) * .25)/4/4 |

As illustrated in table 1 above, the vulnerability assessment may include a physical vulnerability—critical infrastructure assessment value (row 1), which may be calculated as the average of values quantifying the vulnerability level of the energy sector, wastewater, treatment, and airport of a given community. As another example, the Hazard assessment may include a hazard impact assessment value for social impacts (row 24), which may be calculated as the average of one or more values quantifying the special populations, cultural conditions, and socio-economic impact on a community.

Referring to FIG. 2, any community data and/or threat assessment data may be received by the risk management system 202, which may be a personal computer, work station, server, mobile device, mobile phone, processor, and/or other type of processing device and may include one or more processors that process software or other machine-readable instructions. In particular, the risk management system 202 may provide a mechanism, process, and/or application, such as a risk management application 208, which, when executed, generates or otherwise serves one or more interactive interfaces through which a user may provide community and/or threat assessment data. The risk management system 202 may further include a memory to store the software or other machine-readable instructions and data and a communication system to communicate via a wireline and/or wireless communications, such as through the Internet, an intranet, and Ethernet network, a wireline network, a wireless network, and/or another communication network.

The risk management system 202 may include or otherwise be in communication with a database 220 and may include memory and one or more processors or processing systems to receive, process, query and transmit communications and store and retrieve community data and/or threat assessment data. Although the database 220 of FIG. 2 is depicted as being located within the risk management system 202, it is contemplated that the database 220 may be located external to the risk management system 202, such as at a remote location, and may communicate with the risk management system 202 via the communications network 218.

A user interested in conducting a risk assessment may interact with one or more client devices 206 to initiate a request for calculating risk assessments for a particular community, which may be received by the risk management system 202. More particularly, the one or more client devices 206 may also include a user interface (“UI”) application 212, such as a browser application, to generate a request for conducting a risk assessment. In response, the risk management system 202 may transmit instructions that may be processed and/or executed to generate, or otherwise display, the various interactive interfaces. The one or more client devices 206 may be a personal computer, work station, server, mobile device, mobile phone, tablet device, processor, and/or other processing device capable of implementing and/or executing processes, instructions, software, applications, etc. Additionally, the one or more client devices 206 may include one or more processors that process software or other machine-readable instructions and may include a memory to store the software or other machine-readable instructions and data. The one or more client devices 206 may also include a communication system to communicate with the various components of the risk management system 202 via a wireline and/or wireless communications, such as through a network 218, such as the Internet, an intranet, an Ethernet network, a wireline network, a wireless network, a mobile communications network, and/or another communication network.

Alternatively, the risk management system may receive the threat assessment data and/or community data from one or more external system(s) 212 in order to ensure that the data is the most accurate and current. For example, referring to the public health department example, threat assessment data may be obtained from various medical facility systems, medical databases, healthcare provider systems, and/or the like. Community data corresponding to a particular community may be obtained from, for example a U.S. Census database and/or data system, a community-based data system, records, etc. It is contemplated that any external system configured to manage, store, and/or obtain assessment data and/or community data for a particular community may be in communication with the risk management system 202 to enable the risk management system to receive and transmit data from such external systems, for example, in real-time or near real-time.

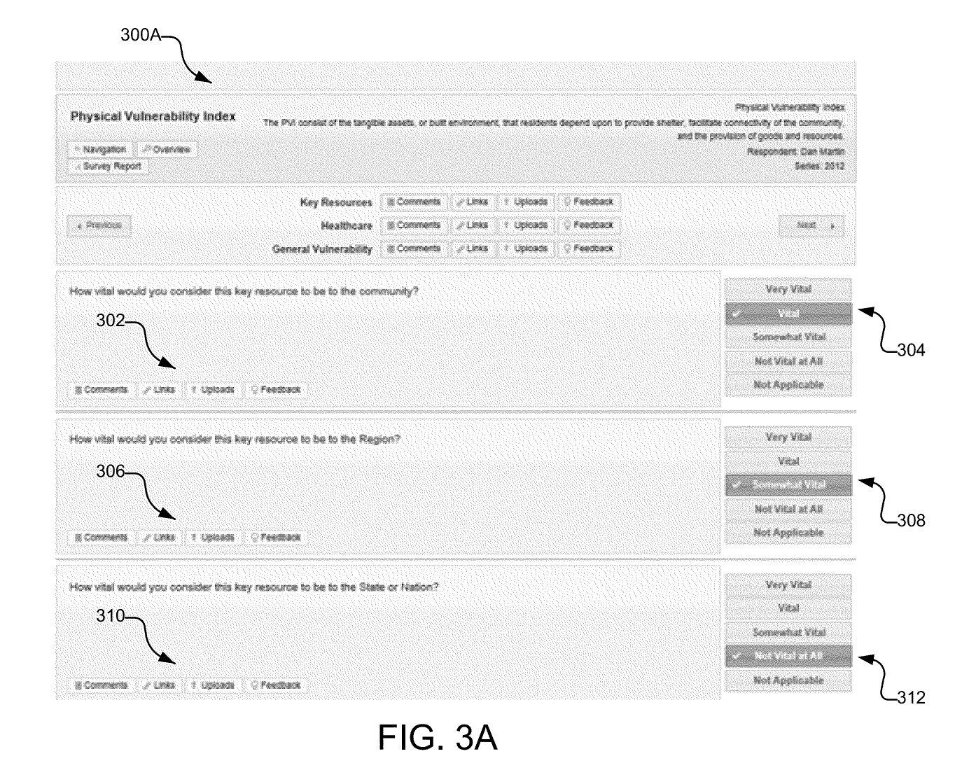

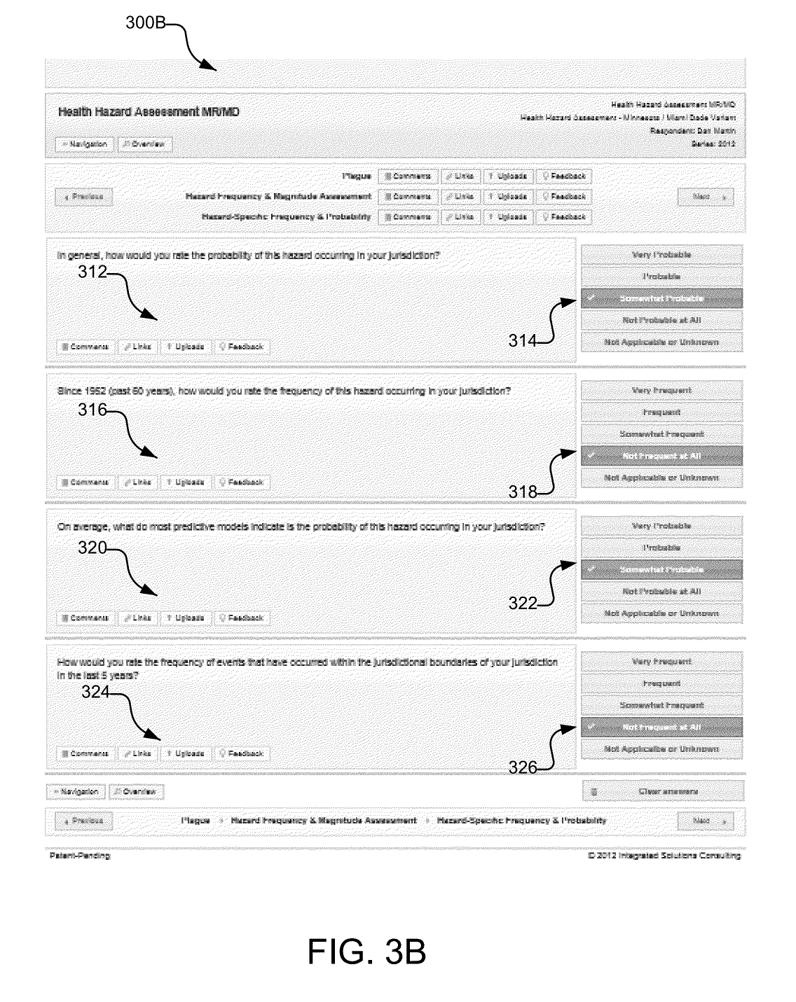

FIGS. 3A-3B represent example interfaces that may be generated by the risk management system 202, according to various embodiments. The interfaces may be used to receive community data and/or threat assessment data. Referring now to FIG. 3A, an interface 300A is depicted that includes one or more components, forms, questions, etc., for receiving threat assessment data. In the illustrated embodiment, the interface 300A includes one or more questions 302, 206, and 310 to which users may provide input responses 304, 308, and 312 respectively to generate the vulnerability assessment. For example, question 302, states: “How vital would you consider this key resource to be to the community?” to which a user may provide input indicating a certain level of vitality at 304—in the illustrated embodiment “vital”. As another example, question 306 states, “How vital would you consider this key resource to be to the Region?” to which a user may provide input indicating that the resource is somewhat vital at 308. The various interfaces may include various interactive elements, such as buttons, forms, fields, selections, inputs, streams, any number of questions, etc., for receiving community data, threat assessment data and/or any combination thereof.

FIG. 3B, represents an interface 300B is that includes one or more components, forms, etc., for receiving threat assessment data to generate a hazard assessment. In the illustrated embodiment, the interface 300B includes one or more questions 312, 316, 320, and 324 to which users may provide input responses 314, 318, 322, and 326 respectively to generate the hazard assessment. For example, question 312, states: “In general, how would you rate the probability of this hazard occurring in your jurisdiction?” to which a user may provide input indicating that the hazard is “somewhat probable” at 314. As another example, question 320 states, “On average, what do most predictive models indicate is the probability of this hazard occurring in your jurisdiction?” to which a user may provide input indicating that the models indicate the hazard as “somewhat probable” at 322. The various interfaces may include various interactive elements, such as buttons, forms, fields, selections, inputs, streams, any number of questions, etc., for receiving community data, threat assessment data and/or any combination thereof.

Referring again to FIG. 1, the community data and threat assessment data may be processed to generate one or more risk assessment scores for the community (operation 108). For example, in one embodiment, a risk assessment score may be calculated according to the following equation: Risk (R)=F*C, where “F” is the frequency/probability of a hazardous event occurring and “C” is the consequence or impact factor of the event occurring. Consequence is a function of the impact of an event (or the consequence) and will be independent on the level of vulnerability, capabilities, and characteristic of the hazard, event or attack. Thus, “C” may be calculated according to the equation: Consequence=(community vulnerability / community capacity)*(magnitude and scale of the threat/community's mitigation and preparedness Efforts).

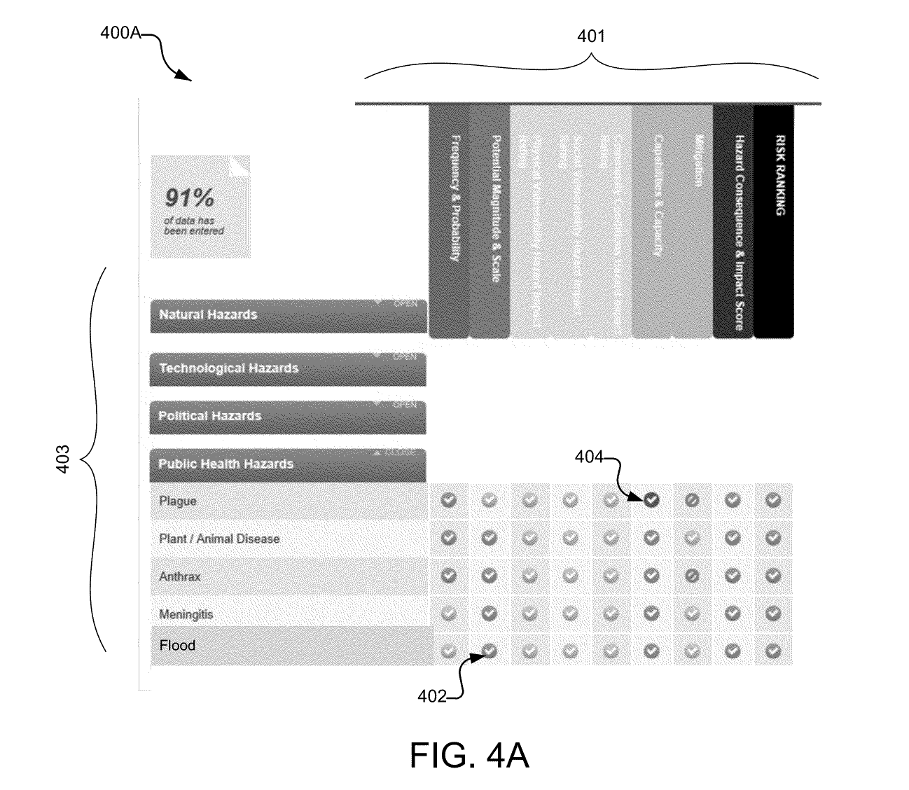

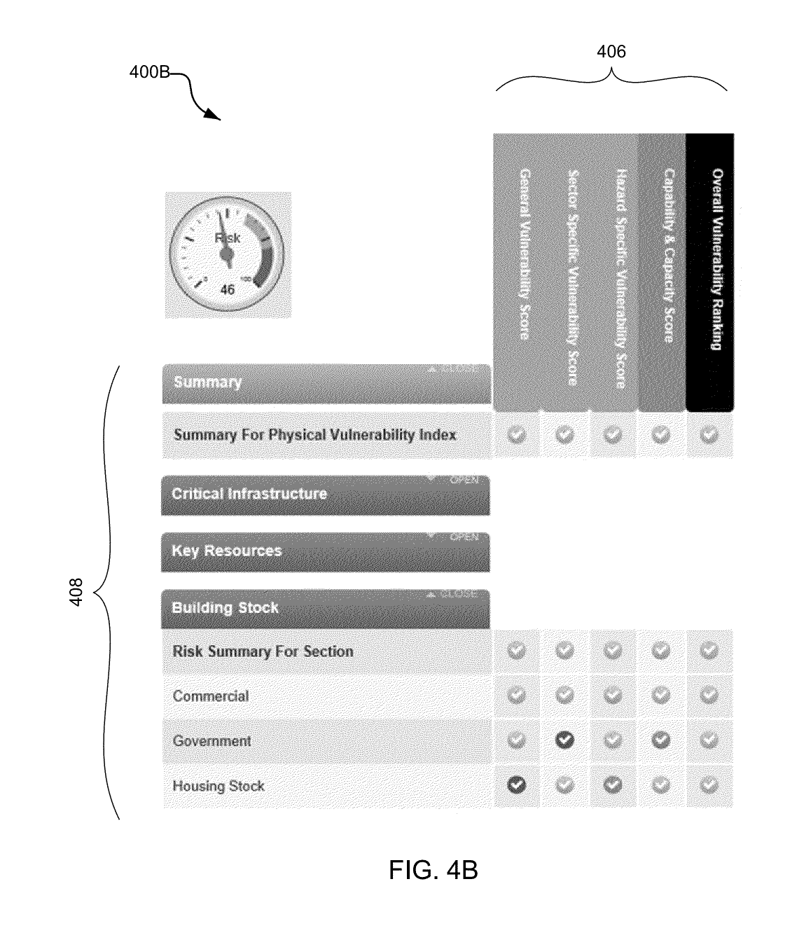

Once one or more risk assessments have been calculated, a risk assessment summary may be generated (operation 108). A risk assessment summary graphically depicts the various real-time or near real-time hazards, risks assessment values, and risk assessments corresponding to a particular community. FIGS. 4A-4B illustrate example risk assessment summaries 400A and 400B according to various embodiments. In the illustrated embodiment of FIG. 4A, the risk assessment summary 400A corresponds to various hazards for the community in which a risk assessment is being conducted. Accordingly, one or more hazards 403 are displayed with corresponding risk assessment values 401. In the illustrated embodiment, the various risk assessment values are quantified according to color scheme ranging from green to red. For example, a green color 402 indicates a relatively low risk assessment value and a red color 404 indicates a high risk assessment value. Alternatively, the various risk assessments may be displayed as percentages. For example, the hazard “flooding” 402 has a corresponding frequency and probability of 56%; a potential magnitude and scale of 27%; a community conditions, social vulnerabilities and physical vulnerabilities (i.e. impact analysis) value of 24%, 31%, and 36% respectively; a Capabilities assessment of 41%; a Mitigation assessment of 67%; a hazard consequence and impact score of 13%; and a risk score of 27%. It is contemplated that any type of graphical representation and/or depiction of the generated risk assessments may be generated. A user may use such information to implement the appropriate measures to mitigate any damage. FIG. 4B, is another example of a risk assessment summary 400B, which illustrates various risk assessments 406 for various physical vulnerabilities and/or hazards 408.

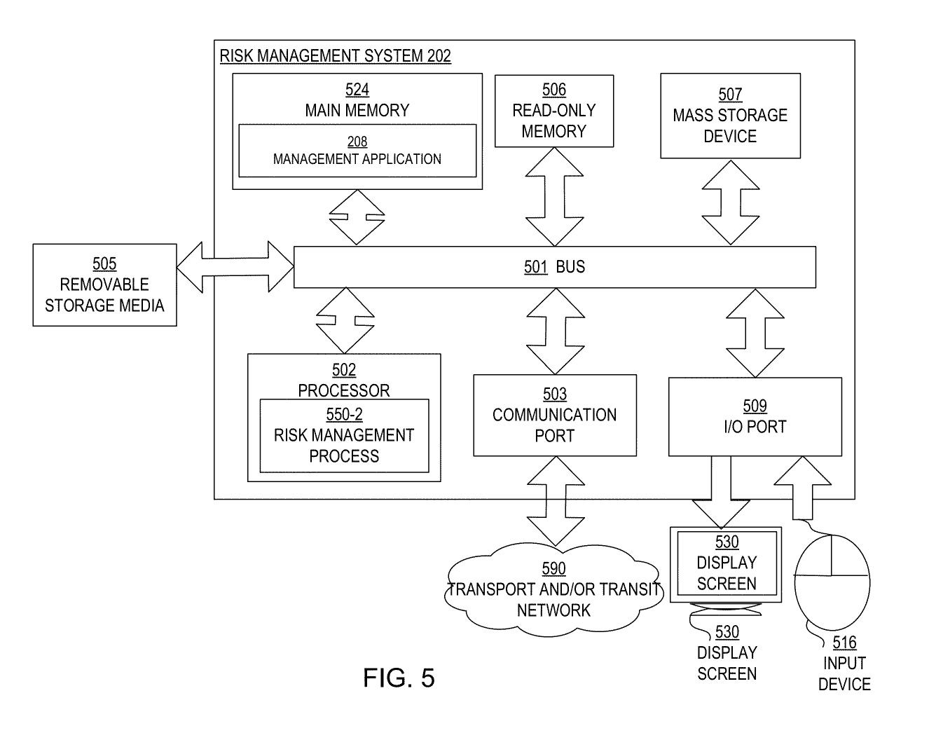

FIG. 5 is another example schematic diagram of a computing system implementing a risk management system 202 that may be used to generate risk assessments, according to one embodiment. The computing system for the risk management system 202 includes a bus 501 (i.e., interconnect), at least one processor 502, at least one communication port 503, a main memory 504, a removable storage media 505, a read-only memory 506, and a mass storage device 507. Processor(s) 502 can be any known processor, such as, but not limited to, an Intel® Itanium® or Itanium 2® processor(s), AMD® Opteron® or Athlon MP® processor(s), or Motorola® lines of processors. Communication port 503 can be any of an RS-232 port for use with a modem based dial-up connection, a 10/100 Ethernet port, a Gigabit port using copper or fiber, or a USB port. Communication port(s) 503 may be chosen depending on a network such as a Local Area Network (LAN), a Wide Area Network (WAN), or any network to which the computer system 100 connects. The ITPKM 202 may be in communication with peripheral devices (e.g., display screen 530, input device 516 via Input/Output (I/O) port 509.

Main memory 504 can be Random Access Memory (RAM) or any other dynamic storage device(s) commonly known in the art. Read-only memory 506 can be any static storage device(s) such as Programmable Read-Only Memory (PROM) chips for storing static information such as instructions for processor 502. Mass storage device 507 can be used to store information and instructions. For example, hard disks such as the Adaptec® family of Small Computer Serial Interface (SCSI) drives, an optical disc, an array of disks such as Redundant Array of Independent Disks (RAID), such as the Adaptec® family of RAID drives, or any other mass storage devices, may be used.

Bus 501 communicatively couples processor(s) 502 with the other memory, storage and communications blocks. Bus 501 can be a PCI/PCI-X, SCSI, or Universal Serial Bus (USB) based system bus (or other) depending on the storage devices used. Removable storage media 505 can be any kind of external hard drives, floppy drives, IOMEGA® Zip Drives, Compact Disc-Read Only Memory (CD-ROM), Compact Disc-Re-Writable (CD-RW), Digital Video Disk-Read Only Memory (DVD-ROM), etc.

Embodiments herein may be provided as a computer program product, which may include a machine-readable medium having stored thereon instructions which may be used to program a computer (or other electronic devices) to perform a process. The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

As shown, main memory 504 is encoded with the risk management application 550-1 that supports functionality as discussed above and as discussed further below. For example, in one embodiment, the risk management application 550-1 may include or otherwise implement the various processes and/or instructions described herein. The risk management application 550-1 (and/or other resources as described herein) can be embodied as software code such as data and/or logic instructions (e.g., code stored in the memory or on another computer readable medium such as a disk) that supports processing functionality according to different embodiments described herein. During operation of one embodiment, processor(s) 502 accesses main memory 504 via the use of bus 501 in order to launch, run, execute, interpret or otherwise perform the logic instructions of the management application 550-1. Execution of the risk management application 550-1 produces processing functionality in application process 550-2. In other words, the ordering process 550-2 represents one or more portions of the ordering application 550-1 performing within or upon the processor(s) 202 in the computer system 500.

The description above includes example systems, methods, techniques, instruction sequences, and/or computer program products that embody techniques of the present disclosure. However, it is understood that the described disclosure may be practiced without these specific details. In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium (e.g., floppy diskette), optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic instructions.

It is believed that the present disclosure and many of its attendant advantages should be understood by the foregoing description, and it should be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it should be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A threat assessment system application comprising:
at least one processor to:
receive threat assessment data corresponding to a community, the threat assessment data including a vulnerability assessment, a capability and capacity assessment, and a hazard assessment;
process the vulnerability assessment, the capability and capacity assessment, and the hazard assessment to calculate at least one risk assessment score quantifying a risk of a threat associated with the community; and
transmit the at least one risk assessment score for display.

2. The system of claim 1, wherein the at least one processor is further configured to generate one or more interactive interfaces for receiving the threat assessment data.

3. The system of claim 1, wherein to transmit the at least one risk assessment for display comprises:
generating a risk assessment summary including the at least one risk assessment score, a first percentage corresponding the vulnerability assessment, a second percentage corresponding the capability and capacity assessment, and a third percentage corresponding to the hazard assessment; and
displaying the risk assessment summary.

4. The system of claim 1, wherein processing the vulnerability assessment, the capability and capacity assessment, and the hazard assessment to calculate the at least one risk assessment score comprises:
calculating a consequence value corresponding to the threat, the consequence value quantifying the impact of the threat occurring on the community; and
calculating the at least one risk assessment score based on the consequence value.

5. The system of claim 1, wherein the threat is an environmental threat and wherein the community is at least one of a business, a city, a state, a public destination, or a governmental entity.

6. The system of claim 1, further comprising receiving a community profile including community data identifying the community.

7. The system of claim 1, wherein threat assessment data is received from at least one external system in real-time.

8. A method for assessing a threat comprising:
receiving, at at least one processor, threat assessment data corresponding to a community, the threat assessment data including a vulnerability assessment, a capability and capacity assessment, and a hazard assessment;
processing the vulnerability assessment, the capability and capacity assessment, and the hazard assessment to calculate at least one risk assessment score quantifying a risk of a threat associated with the community; and
transmitting, at the at least one processor, the at least one risk assessment score for display.

9. The method of claim 8, further comprising generating one or more interactive interfaces for receiving the threat assessment data.

10. The method of claim 8, wherein transmitting the at least one risk assessment for display comprises:
generating a risk assessment summary including the at least one risk assessment score, a first percentage corresponding the vulnerability assessment, a second percentage corresponding the capability and capacity assessment, and a third percentage corresponding to the hazard assessment; and
displaying the risk assessment summary.

11. The method of claim 8, wherein processing the vulnerability assessment, the capability and capacity assessment, and the hazard assessment to calculate the at least one risk assessment score comprises:
calculating a consequence value corresponding to the threat, the consequence value quantifying the impact of the threat occurring on the community; and
calculating the at least one risk assessment score based on the consequence value.

12. The method of claim 8, wherein the threat is an environmental threat and wherein the community is at least one of a business, a city, a state, a public destination, or a governmental entity.

13. The method of claim 8, further comprising receiving a community profile including community data identifying the community.

14. The method of claim 8, wherein threat assessment data is received from at least one external system in real-time.

15. A non-transitory computer readable medium including instructions for assessing a threat, the instructions, executable by a processor, comprising:
receiving threat assessment data corresponding to a community, the threat assessment data including a vulnerability assessment, a capability and capacity assessment, and a hazard assessment;
processing the capability and capacity assessment, and the hazard assessment to calculate at least one risk assessment score quantifying a risk of a threat associated with the community; and
transmitting the at least one risk assessment score for display.

16. The non-transitory computer readable medium of claim 15, wherein further comprising generating one or more interactive interfaces for receiving the threat assessment data.

17. The non-transitory computer readable medium of claim 15, wherein transmitting the at least one risk assessment for display comprises:
generating a risk assessment summary including the at least one risk assessment score, a first percentage corresponding the vulnerability assessment, a second percentage corresponding the capability and capacity assessment, and a third percentage corresponding to the hazard assessment; and
displaying the risk assessment summary.

18. The non-transitory computer readable medium of claim 15, wherein processing the vulnerability assessment, the capability and capacity assessment, and the hazard assessment to calculate the at least one risk assessment score comprises:
calculating a consequence value corresponding to the threat, the consequence value quantifying the impact of the threat occurring on the community; and
calculating the at least one risk assessment score based on the consequence value.

19. The non-transitory computer readable medium of claim 15, wherein the threat is an environmental threat and wherein the community is at least one of a business, a city, a state, a public destination, or a governmental entity.

20. The non-transitory computer readable medium of claim 15, wherein threat assessment data is received from at least one external system in real-time.
